(19) United States
(12) Patent Application Publication
(10) Pub. No.: US 2004/0191918 A1
(43) Pub. Date: Sep. 30, 2004

(54) Evaluation of bitterness of active drugs

(76) Inventors: Sandrine Isz, Toulouse (FR); Eric Chanie, Deyme (FR); Emmanuelle Saint-Martin, Toulouse (FR)

Correspondence Address: WEINGARTEN, SCHURGIN, GAGNEBIN & LEBOVICI LLP, TEN POST OFFICE SQUARE, BOSTON, MA, 02109, US

(21) Appl. No.: 10/402,914

(22) Filed: Mar. 28, 2003

(51) Int. Cl. G01N 27/00

(52) U.S. Cl. 436/149; 422/82.02

(57) ABSTRACT

The bitterness of an active drug can be quantified in an objective manner using an electronic tongue device comprising an array of liquid sensors. During a training phase, the electronic tongue device is presented with samples of known bitterness and a relationship is determined between sample bitterness and the set of outputs of the liquid sensors. This relationship is then used, in a subsequent analysis phase, to produce bitterness values for samples whose bitterness is not known a priori. The electronic tongue device advantageously applies a partial least squares calculation to the sensor outputs when relating sample bitterness to sensor outputs. During the training phase, the samples of known bitterness which are presented to the electronic tongue device can comprise samples containing the same active ingredient at different concentrations.

### FIELD OF THE INVENTION

The present invention relates to methods and apparatus for use in the quantification (or “measurement”)of bitterness of active drugs (and, by extension, in medicaments).

### BACKGROUND ART

In the present document, the expression “medicament” is intended to designate any formulation comprising an active ingredient (“active drug”).

When a pharmaceutical company is developing a new formulation, the active ingredient (active drug) in the formulation will often give the medicament a bitter taste. Although the bitterness can be masked by using other ingredients, for example sugar, or artificial flavours, the choice of excipient depends upon the degree or intensity of the bitterness of the active drug.

At present there is no technique available for obtaining an objective measurement of the bitterness intensity of an active drug. Traditionally, an assessment of the bitterness of an active drug is obtained using a human panel of tasters. However, this approach has a number of disadvantages, the chief of which is the fact that the assessment of bitterness that is obtained is subjective. In an attempt to render the assessment less subjective the size of the tasting panel can be increased, but this does not eliminate the problem. Moreover, in order for an active drug or a formulation to be testable by a human panel, each component (including the active drug) in the formulation must be approved by governmental authorities (and the approval process can often take months or even years). Furthermore, there is a risk of toxicity and/or side effects when an active drug is administered to humans, and the panel of tasters may subsequently be untreatable by the medicament in question.

In other fields, notably, the brewing industry, there is an established scale for quantifying the bitterness of beers, and known techniques for measuring bitterness. More particularly, the bitterness of a beer can be expressed in terms of International Bitterness Units (IBUs), with a normal range of bitterness in “international” beers being from 20 to 40 IBUs. It is the isomerized alpha acids, derived from hops, which give the beer its bitter flavour and one IBU equals one milligram of isomerized alpha acid in one litre of beer (or one part per million). The bitterness of a beer is conventionally measured by acidifying the beer, extracting the alpha acids using iso-octane, and then measuring the absorbance (at 275 nm) of the extracted substances using a spectrophotometer.

It will be seen that the conventional method for quantifying bitterness of beers is really a technique for measuring the isomerized alpha acid content of the beer. Accordingly, this bitterness-measurement technique cannot be applied in the field of quantifying bitterness in medicaments.

Work has also been performed within the assignee company to analyse properties of beers using an electronic tongue device-see the article “The Electronic Tongue” in the European Food and Drink Review, Issue 3, 2001. Various properties were analysed, including taste variation from one batch of a beer to another, presence of an “off” taste, and bitterness.

The present inventors have discovered that an electronic tongue device can be used to provide an accurate measurement of bitterness of active drugs and, by extension, of medicaments.

### SUMMARY OF THE INVENTION

It is an object of the present invention to provide a method of quantifying the bitterness of a sample, notably an active drug.

It is a further object of the present invention to provide a bitterness-quantification apparatus.

More particularly, the present invention provides a method of quantifying the bitterness of an active drug, the method comprising the steps of:

providing a calibrated electronic tongue device, said electronic tongue device comprising a plurality of sensors, the electronic tongue device having been calibrated by a process consisting of presenting to the electronic tongue a plurality of training samples having known bitterness values, determining the responses of the electronic tongue sensors to the training samples, and processing the sensor responses whereby to determine a relationship converting between sensor responses and known bitterness values;

presenting the sample to the calibrated electronic tongue device;

determining the responses of the sensors in the electronic tongue to the presented sample; and

processing the determined sensor responses, according to the determined conversion relationship, to produce a bitterness value for the sample.

By basing the measurement of bitterness on the responses of a set of sensors in an electronic tongue device, the method of the present invention provides an objective measurement of the bitterness of an active drug by a technique which does not involve risk to human tasters.

Moreover, by using an electronic tongue device in the quantification of the bitterness of an active drug, the method of the present invention is capable of evolution. More particularly, the relationship used to convert between sensor responses and bitterness values can be updated in a dynamic manner, as and when additional training samples become available (see below).

The present invention further provides a bitterness-quantification method which includes the above steps and, in addition, the step of calibrating the electronic tongue device. The calibration process makes use of a set of training samples for which bitterness values have already been obtained, typically from tasting by a human panel (referred to herein as “in vivo” testing).

During the calibration of the electronic tongue device, a number of different analytical techniques can be used in order to process the multi-variate sensor response data. Amongst the available methods there are multi-linear regression (MLR), principal component regression (PCR) and partial least squares (PLS) technique. However, the Partial Least Squares approach has been found to give the best results and, thus, is the preferred approach.

When calibrating the electronic tongue device, it is preferred to have a two-stage process. During the first stage, a number of training samples are presented to the electronic tongue device and a relationship is determined between the sensor responses and the known bitterness values for these training samples. During the second stage, the determined conversion relationship is validated (or found to be deficient) by presenting a further group of samples of known bitterness to the electronic tongue and noting the bitterness values that are produced for this set based on the determined conversion relationship. If the bitterness values are close to the “known” values then the conversion relationship is considered to be validated and the electronic tongue device is considered to be calibrated. Otherwise, a fresh attempt is made to determine an appropriate conversion relationship.

Electronic tongue devices can make use of sensors having different transducers, for example, potentiometric, amperometric, quartz microbalances, surface acoustic wave devices, ISFETs, etc. However, it is preferred to use ISFET sensors in the electronic tongue device employed in the present invention because ISFET sensors can be manufactured with consistent properties, and produce an output rapidly and with good reproducibility.

When applying the method of the present invention, it has been found to be helpful to include amongst the training samples presented to the electronic tongue device different samples containing a given active drug at respective different concentrations. Furthermore, impressive results have been obtained using the method of the present invention when the electronic tongue device is calibrated using training samples consisting of the following set of active drugs: caffeine, famotidine, loperamide, paracetamol, prednisolone, and quinine.

Bitterness-measurement apparatus implementing the above-described methods also come within the scope of the present invention. More particularly, the present invention further provides apparatus for quantifying the bitterness of an active drug, the apparatus comprising: a calibrated electronic tongue device comprising a plurality of sensors, the calibrated electronic tongue device having stored therein means for producing a bitterness value by applying a determined conversion relationship to sensor responses generated upon presentation of a sample to the electronic tongue device; and means for presenting a sample under test to the calibrated electronic tongue device.

Further features and advantages of the present invention will become apparent from the following description of preferred embodiments thereof, given by way of example, and elucidated with reference to the drawings described hereinafter.

### BRIEF DESCRIPTION OF THE DRAWINGS

FIG. 1 is a diagram showing, schematically, a first preferred embodiment of a bitterness quantification system according to the present invention, in which:

FIG. 1A is a block diagram indicating the main components of the system, and

FIG. 1B is a diagram indicating, schematically, the first preferred embodiment as implemented using an α ASTREE electronic tongue device;

FIG. 2 is an example of a scale that can be used in order to relate numerical values to perceived bitterness;

FIG. 3 is a flow diagram indicating the main steps in a first preferred embodiment of the bitterness quantification method of the present invention;

FIG. 4 is a graph plotting known bitterness values for a set of training samples against values calculated by a bitterness-quantification system according to a presently-preferred embodiment of the present invention;

FIG. 5 is graph plotting unknown bitterness samples determination (at x=0) on the graph for the set of training samples which are the object of FIG. 4;

FIG. 6 is a graph plotting bitterness values for an increased set of training samples against values calculated by the bitterness-quantification system according to the presently-preferred embodiment of the present invention; and

FIG. 7 is a graph showing the variation in bitterness values produced by a human panel and the variation in bitterness values produced by the bitterness-quantification system according to the presently-preferred embodiment of the present invention.

### DETAILED DESCRIPTION OF THE PREFERRED EMBODIMENTS

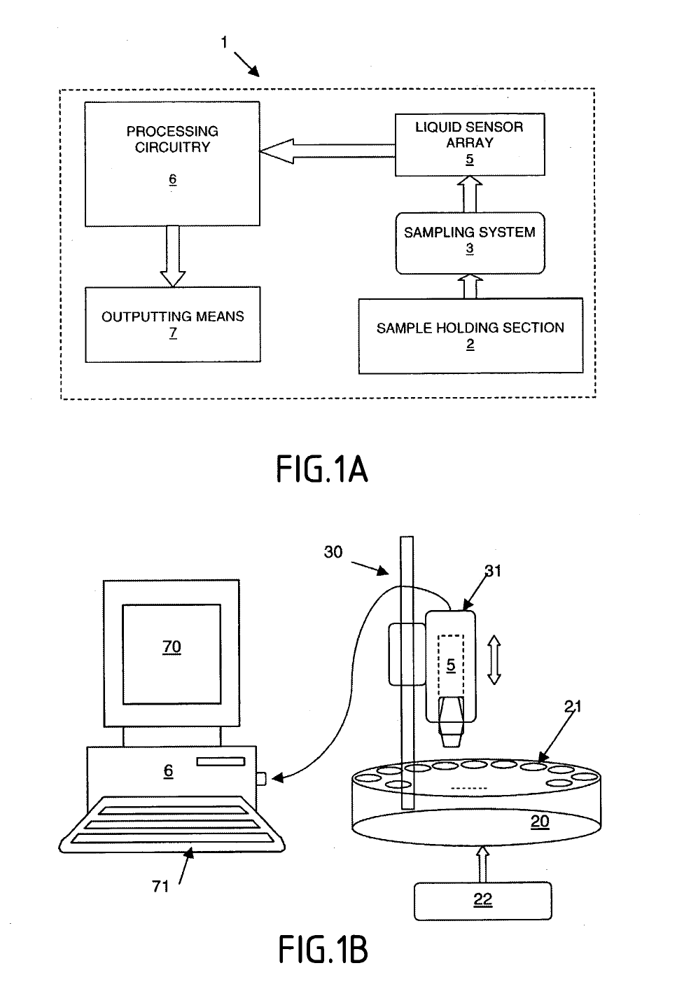

FIG. 1 is a schematic representation of a first preferred embodiment of apparatus according to the present invention. As shown in FIG. 1A, the apparatus comprises an electronic tongue system, indicated generally by the reference 1. In this embodiment, the electronic tongue system 1 includes a sample holding section 2, a sampling system 3, an array 5 of liquid sensors, processing circuitry 6, and means 7 for outputting the results of the processing.

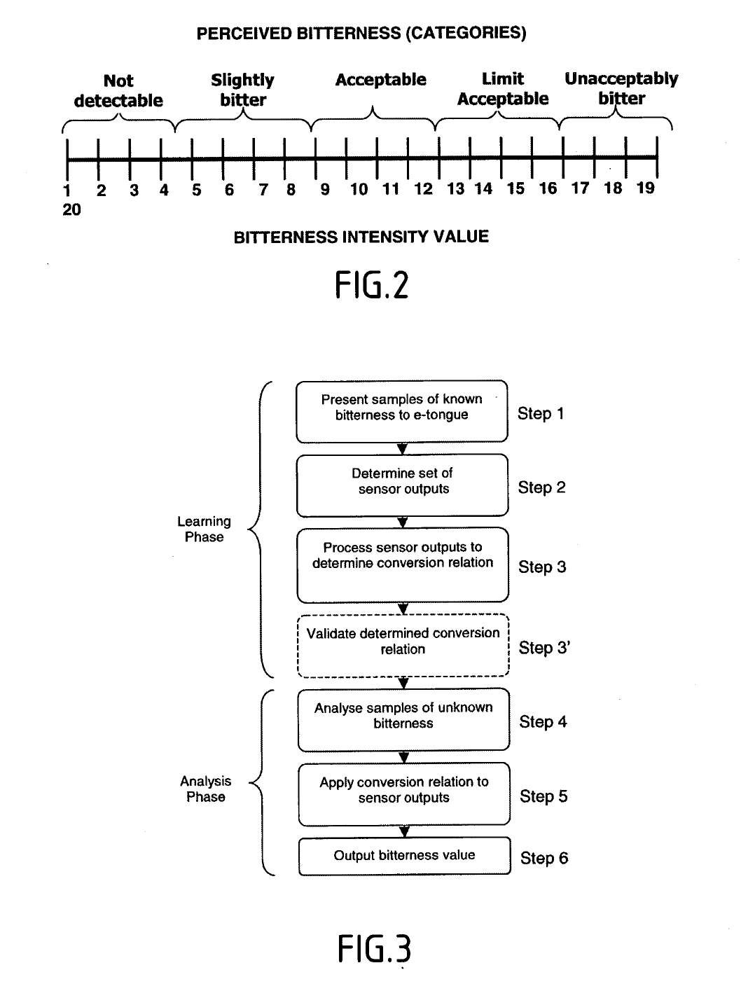

The task of the electronic tongue system employed in the present invention may be described as evaluating a bitterness value for a sample whose bitterness is not known a priori. The evaluated bitterness value can be understood intuitively if it is related to bitterness as perceived by a human taster. For example, bitterness values can be expressed on a scale running from 1 to 20, with substances having no discernible bitter taste being assigned a low bitterness value and substances having an extremely bitter taste being allocated a high value. FIG. 2 illustrates one such suitable scale, which has been used when developing the present invention. FIG. 2 relates numerical bitterness values to bitterness intensity as perceived by a human taster or panel, as follows:

| | Perceived Bitterness |
|---|---|
| Bitterness Value | Intensity |
| 1.0 to 4.49 | Undetectable bitterness |
| 4.5 to 8.49 | Slight bitterness |
| 8.5 to 12.49 | Acceptable |
| 12.5 to 16.49 | Bitter but limit of |
| | acceptability |
| 16.5 to 20.0 | Unacceptably bitter |

The electronic tongue system used in the present invention may be designed to evaluate a numerical value for bitterness and/or to evaluate which bitterness category applies to a sample under test (based on a scale of bitterness categories such as that of FIG. 2, or any other suitable scale).

A wide variety of electronic tongue devices have been proposed by different companies and researchers. For example, researchers at the University of Texas have proposed an electronic tongue device which uses optical detectors to visualise the change of color of a sensitive layer reacting with a given sample. Researchers at Cardiff University, Great Britain, have proposed an electronic tongue device which integrates highly-miniaturised chromatographic devices on a substrate. Other researchers have proposed electronic devices using arrays of electrochemical liquid sensors having overlapping sensitivities. In the assignee company's U.S. Pat. No. 6,290,838 an electronic tongue device is proposed in which liquid sensors of different technologies are associated with one another. The present invention may be applied without limitation to the various different kinds of electronic tongue devices.

However, preferably, the present invention makes use of an electronic tongue device having an array of electrochemical liquid (ISFET-based) sensors having overlapping sensitivities, associated with a processing system using multivariate analysis. This kind of electronic tongue device is easy to use, provides a rapid measurement and, when associated with or incorporating an autosampler, has high throughput. In many cases no special preparation of the sample is required. Yet more preferably, the electronic tongue device used in the present invention is an α ASTREE electronic tongue system manufactured by the assignee company, Alpha MOS, of Toulouse, France.

When using the α ASTREE electronic tongue system, the sampling holding section 2 is structured as a carousel 20, which can hold at least sixteen beakers 21. Preferably one beaker is used to hold a liquid for use in cleaning the sensor array 5. Sample preparation is simple, the sample need only be prepared in liquid form and placed in a beaker 21 of the carousel.

In the α ASTREE electronic tongue system the sampling system 3 is an automatic sampler 30 comprising a sampling head 31. The sample holding section 2 includes a stepping motor 22 for rotating the carousel 20 in a stepwise fashion so as to present different samples to the sampling head 31 when desired. The action of the sampling head 31 and operation of the stepping motor 22 are preferably controlled by software, such as is present in the processing circuitry 6 of the α ASTREE electronic tongue system.

When sampled by the sampling head 31, a sample of liquid present in a flask 21 is presented to a sensor array 5, which can be located within the sampling head 31 itself. Typically, the sensor array used in an electronic tongue system will include a set of non-specific liquid sensors, with overlapping sensitivities. The sensors are “non-specific” by opposition to “specific” sensors which give an output or no output depending upon the presence or absence of a given molecule, respectively. The main kinds of liquid sensors that are commercially available are ion-selective electrodes, chemical microelectrodes and biosensors.

The presently-preferred embodiment of the invention makes use of an array of seven ISFET sensors in an α ASTREE electronic tongue system. It has been found that ISFET devices can be fabricated with greater uniformity (or “reproducibility”)of properties than many other sensors. Furthermore, measurements can be made more rapidly using ISFET devices. Each sensor comprises a silicon transistor bearing a respective different organic coating. The organic coatings are composed of different sensitive molecules encapsulated in a polymer and are selected so as to be non-specific (or partially-specific) with different, but overlapping, sensitivities.

The person skilled in the art is well aware of different sensitive molecules (typically, ionophores, crowns, amines, calyx[n]arenes, cocktails, phosphates, amides, cycloalkanes, esters, ketones) which are suitable for such encapsulation and use in a liquid sensor, and of techniques for fabricating liquid sensors including such molecules. See, for example, U.S. Pat. No. 5,350,701.

For each one of the seven sensors, sensor output is measured by determining the difference between the potential of that sensor versus the potential of a reference electrode (in this case a silver/silver chloride reference electrode). Methods of fabricating ISFET liquid sensors and reference electrodes are well-known to the person skilled in the art. The set of sensor outputs generated for a given sample is processed by the processing circuitry 6 in order to determine data characterising, or describing properties of, that sample.

This processing circuitry 6 is advantageously constituted by an appropriately-programmed general purpose computer and enables data generated by the sensor array to be saved, processed and visualised. Typically, the processing circuitry will have an advanced chemometric software package loaded therein. A main aim of the software package is to analyse the set of sensor outputs so as to extract relevant features therefrom, notably to determine a relationship between that set of outputs and the bitterness of the sample under test. The software package will include routines for performing a multivariate analysis (each sensor's output constituting a respective different one of the variables). The processing circuitry can also compare the results of its own calculations with results obtained by other analyses.

Advantageously, the analysis performed by the software package may enable the dimensionality of the problem to be reduced. For example, it may be found that the outputs of certain sensors do not serve to help distinguish samples of different degrees of bitterness from each other. Alternatively, and more usually (assuming that the sensors have been chosen appropriately), one or more composite variables can be produced by combining outputs from different sensors in given proportions. The task of relating sensor outputs to bitterness values thus reduces to a task of relating composite variables to bitterness values, the number of composite variables being smaller than the number of sensor outputs.

This software package typically will include one or more modules for evaluating the set of outputs produced by the sensor array 5, each module using a respective statistical method that could be clustered, as follows:

exploratory methods, such as Principal Components Analysis (PCA),

identification methods, such as Discriminant Factorial Analysis (DFA) or Soft Independent Modelling by Class Analogy (SIMCA), and

quantitative methods (as preferred in the present invention) such as Partial Least Squares (PLS), Multi-Linear Regression (MLR), and Principal Component Regression (PCR).

These methods contains three main phases:

Model building;

Validation;

Unknown sample prediction.

The input data for training (or “calibration”)of the electronic tongue is defined as follows:

A matrix S of t*n dimensions:

the generic term S(j,i) of S is the sensitivity of sensor i for sample j,

n is the number of sensors in the array, and

t the number of training samples

A vector C of t dimensions:

C(j) is the known bitterness value of a given training sample j,

After model building completion, the calculated parameters are used to estimate the bitterness level Bx of an unknown sample X.

When MLR is used, the analysis seeks to calculate a vector A (n dimensions), according to the following equation:

$$C ( j ) = {\sum }_{i = 1}^{n} A ( i ) S ( j , i ) + E ( j )$$

where E(j) is the residual error of the model for sample j.

Once vector A has been calculated, measurement is performed on unknown sample X and the sensor responses' vector is noted as Sx. The bitterness Bx is then estimated using:

$${B}_{X} = {\sum }_{i = 1}^{n} A ( i ) {S}_{X} ( i )$$

When PCR is used, the analysis seeks to calculate a vector A′ of m dimensions. The number m of principal components (PC) used is inferior or equal to n.

$$\begin{matrix}C ( j ) = {\sum }_{p = 1}^{m} {A}^{′} ( p ) PC ( j , p ) + E ( j ) \\ PC ( j , p ) = {\sum }_{k = 1}^{n} B ( k , p ) S ( j , k )\end{matrix}$$

One notes PCx, the correspondent principal component of X, Bx is then estimated as follows:

$$Bx = {\sum }_{p = 1}^{m} {A}^{′} ( p ) {PC}_{x} ( p )$$

Research within the assignee company has found that a Partial Least Squares approach gives excellent results when seeking to quantify the bitterness of active drugs present in sample formulations. A PLS approach consists in calculating a vector V and two matrices T & U which increase correlation between bitterness value vector C and sensor responses matrix S for the group of training samples. T is chosen with smaller dimension 1.

$$\begin{matrix}C ( j ) = {\sum }_{q = 1}^{l} T ( j , p ) V ( p ) + E ( j ) \\ S ( j , i ) = {\sum }_{q = 1}^{l} T ( j , p ) U ( p , i ) + E ( j , i )\end{matrix}$$

For determining Bx, the following calculation are applied

After calculating the vector {Tx(k), k=1 to 1} for the unknown sample, the bitterness Bx is then estimated by

$$Bx = {\sum }_{k = 1}^{l} V ( k ) Tx ( k )$$

The results of processing by the processing circuitry 6 can include various different data including, but not limited to: a “known” bitterness value applicable to a sample undergoing analysis; an “unknown” bitterness value allocated to a sample undergoing analysis; data labelling a particular sample (e.g. sample number X); a graph, etc., representing the relationship between bitterness values as calculated by the apparatus 1 and bitterness values allocated to samples by another source (typically a panel of human tasters); etc.

By suitable programming of the processing circuitry 6, any or all of the data acquired and processed thereby can be made available for output, preferably by display on a monitor 70 and, advantageously, according to selection made by a user using a suitable command-input device (e.g. a keyboard 71, mouse, etc). The monitor 70 can additionally or alternatively display any desired data available within the system 1 as a whole, such as the acquisition parameters, analysis steps, etc. It should be understood that the results generated by the processing circuitry could be output in any other convenient fashion, for example, by lighting one or more LEDs (e.g. a red LED if the calculated bitterness value exceeds a predetermined threshold, or a number of LEDs which is related to the calculated bitterness value, etc.) by outputting results to a printer or other data-output device, by storing results on a suitable storage medium (CD-ROM, DVD, disc, tape, etc), by transmitting results over a data transmission network (intranet, Internet, etc,), etc.

A preferred embodiment of a method according to the present invention for quantifying the bitterness of sample formulations containing active ingredients, will now be described with reference to the flow diagram of FIG. 3. In the present embodiment, the α ASTREE electronic tongue system is used.

As shown in FIG. 3, the bitterness-quantification method of the present preferred embodiment has two main phases: a training phase (steps 1 to 3 or 3′) and an analysis phase (steps 4 to 6).

In the training phase, a number of training samples of known bitterness are presented to the electronic tongue system 1 (step 1). Bitterness values for these training samples are typically known because the samples have been evaluated beforehand “in vivo”. The present inventors have found that the results obtained by the overall method are improved if the training samples include samples of a set of different active drugs. The presently-preferred set of active drugs used during the training phase is: caffeine, paracetamol, prednisolone and quinine. Moreover, the present inventors have discovered that the efficacy of the overall method is improved if the active drugs used in the training phase are included at different concentrations in different training samples. By varying the concentration of an active drug in different training samples, the perceived bitterness varies between these training samples.

For each training sample presented to the electronic tongue device, the set of outputs from the sensors is determined (step 2). It is preferable to wait until each sensor in the array has reached an equilibrium state before noting the output from that sensor. Typically, this requires the sensor to be exposed to the sample for a time period of the order of two minutes. It is convenient to store the acquired data in raw data files, which can build up into a data library. This “library” can take the form of a matrix, in which each line corresponds to a particular sample, and each column corresponds to the output from a given sensor of the sensor array 5.

The processing circuitry of the electronic tongue system 1 processes the sets of sensor responses produced for the training samples, in an attempt to determine a relationship which will correlate the sensor outputs with the known bitterness values (step 3). Statistical interpretation methods are needed in order to interpret this multivariate data. Chemometric techniques enable the data to be presented in an understandable format for specific requirements. It has been found, as mentioned above, that when a linear combination of the sensor responses is made using a partial least squares approach, in order to arrive at a single value representing the set of sensor responses for a particular training sample, the way in which this single value varies between training samples correlates well with the bitterness values provided by in vivo testing.

By processing the set of sensor outputs produced for the set of training samples a conversion relationship is determined which produces the best correlation between calculated bitterness values and known (in vivo) bitterness values. In the case of using PLS, this conversion relationship is expressed by calculation of matrices [U] and [V] as defined above.

Once the conversion relationship has been established it is possible to use the system for analysing samples whose bitterness is not known a priori. In other words, the analysis phase can begin. However, in order to have greater confidence in the performance of the system, it can be useful to perform an additional “validation” step (step 3′) at the end of the learning phase. In this validation step, further samples of known bitterness are presented to the system and the system calculates bitterness values for these “validation” samples by applying the estimated conversion relationship. The thus-calculated bitterness values are compared with the known bitterness values and, if the correlation is sufficiently good (for example, above a threshold level, such as 0.75), then the estimated conversion relationship is considered to be sufficiently good to use in analysis of samples of unknown bitterness—thus the conversion relationship is considered to be validated.

When the learning phase is complete the system includes a calibrated electronic tongue device and can be used to produce a bitterness value for an active drug and whose bitterness is not known a priori. In this analysis phase, a sample of unknown bitterness is placed in a beaker 21 and sampled so as to be presented to the sensor array 5 (step 4). The sensors responses are noted when the sensors have reached an equilibrium condition (after a short time interval, as before). The set of sensor responses is processed according to the conversion relationship that was estimated during the learning phase (and, if relevant, validated during a validation phase)—see step 5. The bitterness value resulting from this calculation is output as a measurement of the bitterness of the sample (step 6).

It should be mentioned that the system for measuring bitterness of active drugs according to the present invention is capable of evolution. More particularly, the conversion relationship determined during the learning phase can be updated, at any desired time, by presenting the apparatus with additional training samples. Preferably, the apparatus re-determines the optimal conversion relationship by processing the sensor output data obtained for the new training samples together with the initial sensor output data obtained for the initial set of training samples. The freshly-determined conversion relationship can then be used for subsequent analyses performed by the system.

Experiments

In order to demonstrate the performance of the method according to the present invention a number of experiments were performed. For these experiments, 12 test solutions (detailed in Table 1 below) were prepared using the following method:

a) in a 200 ml flask, introduce the corresponding weight from Table 1 below (or the corresponding volume of mother solution, in appropriate cases),

b) add 150 ml of distilled water,

c) sonicate during 10 minutes, and

d) add further water to bring the volume up to 200 ml in total.

If (e.g. for test solutions FA01 and FA02 of Table 1 below) dilution is needed from a mother solution (e.g. test solution SMA), no sonication is needed at this stage (this step is only performed for the “mother solution”).

These solutions were used to provide training or validation samples, with 80 ml of the relevant solution being placed in a beaker 21 of the sample holding section 20.

TABLE 1

| | Solution | Weight (mg) unless | |
|---|---|---|---|
| Active | Reference | otherwise | Concentration |
| Ingredient | Code | stated | (mg/ml) |
| CAFFEINE | CA16 | 10 ± 0.5 | 0.05 |
| | CA14 | 100 ± 1 | 0.5 |
| PARACETAMOL | PA03 | 100 ± 1 | 0.5 |
| | PA09 | 600 ± 1 | 3 |
| PREDNISOLONE | PR26 | 50 ± 1 | 0.25 |
| | PR25 | 100 ± 1 | 0.5 |
| FAMOTIDINE | SMA* | 200 mg | 1 |
| | FA01 | 4.0 ml of | 0.02 |
| | | SMA | |
| | FA02 | 10.0 ml of | 0.05 |
| | | SMA | |
| LOPERAMIDE | SM1* | 20 mg | |
| | SM2* | 20 ml de SM1 | |
| | LO21 | 20.0 ml de | 0.001 |
| | | SM2 | |
| | LO20 | 10.0 ml de | 0.005 |
| | | SM1 | |
| QUININE | SM3* | 40 mg | |
| | QU22 | 40.0 ml de | 0.04 |
| | | SM3 | |
| | QU23 | 10.0 ml de | 0.01 |
| | | SM3 | |

*this solution was not used directly in a training sample, but as a mother solution for preparation of other solutions.

Experimental Conditions:

The Experiments were performed using an α Astree electronic tongue instrument configured as described above. The instrument used an array of seven sensors. Each sensor was composed of a given different sensitive organic coating deposited on an ISFET sensor (a transducer which allows conversion of the response of the membrane into electrical signals). For each sample, measurements were repeated in order to check the reproducibility of the method and to enhance the statistical data processing performance.

In these experiments, the volume of each test solution present in a beaker 21 was 80 ml. The samples were at room temperature. The sampling head 31 was introduced into each sample in turn, remaining in each sample for 120 seconds. Then the sampling head 31 was rinsed (for 10 seconds, in this example) using a rinsing solution present in one of the beakers 21 of the carousel 20. Thus, there was an interval of 180 seconds between each sample analysis. When the sampling head 31 was in a given sample, the ISFET sensors of the sensor array 5 generated responses to the sample.

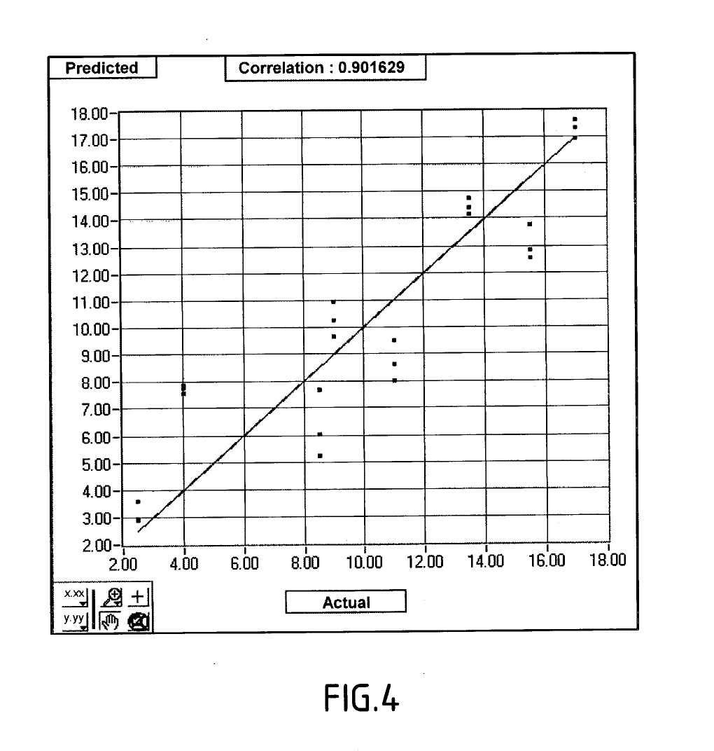

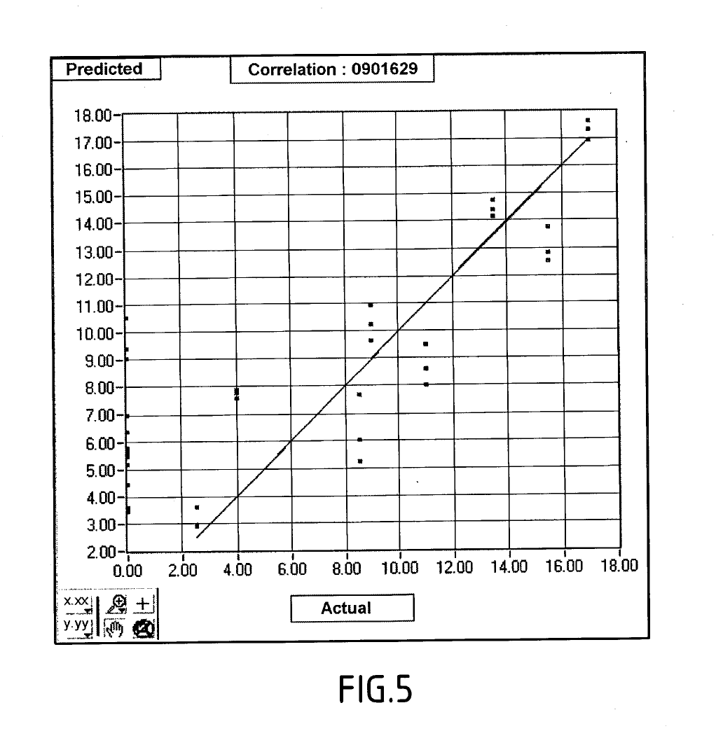

In a first test of the preferred embodiment of bitterness-measurement method of the present invention, 8 training samples (CA14, CA16, PA03, PA09, PR25, PR26, QU23 and QU22) were used to calibrate the electronic tongue and then 4 validation samples (FA01, FA02, L020 and L021) were presented to the calibrated apparatus. In vivo evaluations of bitterness were known for all of the samples. FIG. 4 shows the results of Test 1.

In FIG. 4 , the “actual” bitterness values, determined by in vivo testing are plotted on the x-axis. The “predicted” bitterness values calculated by the system are plotted on the y-axis. For each of the 8 training samples, FIG. 4 shows the bitterness value calculated for each analysis of that sample as a black dot. The diagonal line in FIG. 4 indicates the case where predicted bitterness value is equal to the in vivo bitterness value. The training sample positions on FIG. 4 correspond to the points yielded when the correlation is optimised using a PLS approach. In the present example, the correlation obtained was very good (correlation coefficient of 0.90).

Table 2 summarises the actual and calculated bitterness values for the 8 training samples, using the estimated conversion relationship which optimises correlation.

TABLE 2

| | | | In Vivo(Panel) | | | |
|---|---|---|---|---|---|---|
| | | | Bitterness Index | | “Measured” Bitterness | |
| Sample | | Conc. | Average | | Average | |
| Ref. | Active Drug | (mg/ml) | Index | Category | Index | Category |
| CA14 | Caffeine | 0.05 | 2.5 | Undetectable | 3.1 | Undetectable |
| | | | | bitterness | | bitterness |
| CA16 | Caffeine | 0.05 | 8.5 | Acceptable | 6.3 | Slightly bitter |
| PA03 | Paracetamol | 0.5 | 17 | Not Detectable | 14.1 | Slightly bitter |
| PA09 | Paracetamol | 3 | 10 | Acceptable | 13.6 | Slightly bitter |
| PR26 | Prednisolone | 0.25 | 13.5 | Bitter Limit | 14.5 | Bitter Limit |
| | | | | acceptable | | acceptable |
| PR25 | Prednisolone | 0.5 | 17 | Unacceptably | 17.3 | Unacceptably |
| | | | | bitter | | bitter |
| QU23 | Quinine | 0.01 | 9 | Acceptable | 10.3 | Acceptable |
| QU22 | Quinine | 0.04 | 15.5 | Limit | 13.0 | Limit |
| | | | | Acceptable | | Acceptable |

The conversion relationship which yielded the graph of FIG. 4 for the training samples was applied to the sets of sensor responses obtained for the 4 validation samples. During the validation phase, the “actual” bitterness values for these samples are, initially, ignored-so the different repeats of analysis for these validation samples are plotted on FIG. 5 at the position x=0, using open circles. Table 3 summarises the predicted and actual bitterness values for the validation samples:

TABLE 3

| | | | In Vivo(Panel) | | | |
|---|---|---|---|---|---|---|
| | | | Bitterness Value | | “Measured” Bitterness | |
| Sample | | Conc. | Average | | Average | |
| No. | Substance | (mg/ml) | Index | Category | Index | Category |
| FA01 | Famotidine | 0.02 | 4.2 | Undetectable | 3.5 | Undetectable |
| | | | | bitterness | | bitterness |
| FA02 | Famotidine | 0.05 | 9 | Acceptable | 3.8 | Undetectable |
| | | | | | | bitterness |
| LO21 | Loperamide | 0.001 | 7.5 | Slightly bitter | 6.4 | Slightly bitter |
| LO20 | Loperamide | 0.005 | 14.0 | Limit but | 9.7 | Acceptable |
| | | | | Acceptable | | |

The average difference in bitterness measurement between “predicted” values and “actual” values was 2.8. The results are sufficiently close to consider the estimated conversion relationship to be validated. (The decision whether or not to validate the conversion relationship can be based on a comparison of the discrepancy between actual and predicted bitterness values and a threshold value, as here, or on a comparison between the correlation coefficient for the validation samples and a threshold value, or on any other convenient criterion).

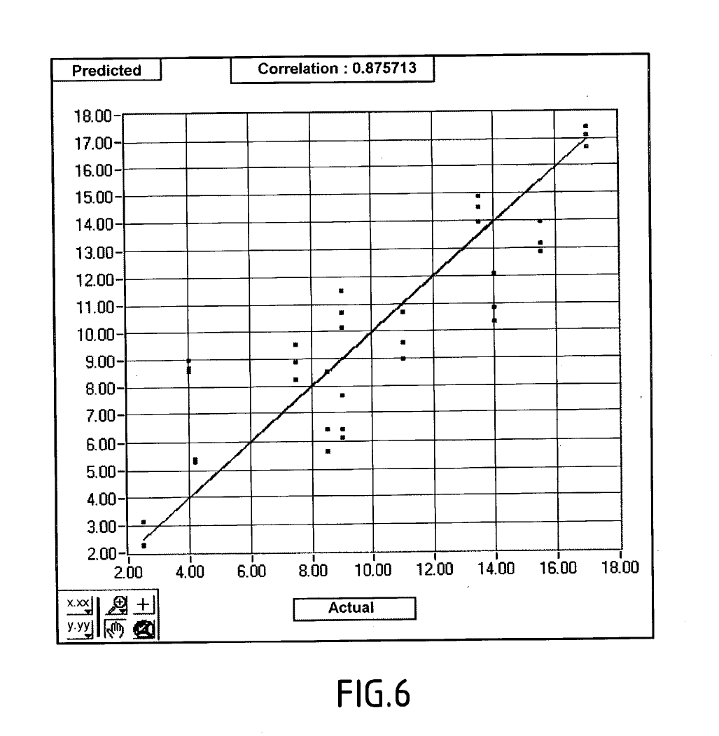

A further test was conducted of the presently-preferred embodiment of the invention, in which the 4 validation samples were added to the 8 samples previously used to train the system, so as to give 12 training samples in total. FIG. 6 shows the correlation between in-vivo measurements and predicted bitterness values when all 12 samples were used for training the apparatus.

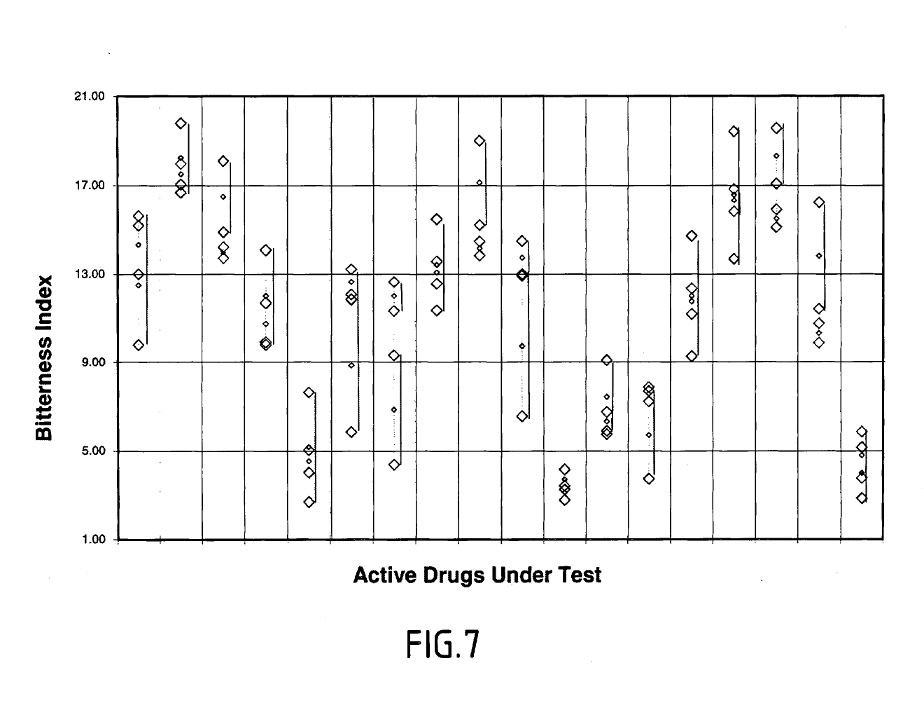

In order to put into perspective the variation that is perceived in the bitterness values that are calculated by the system in the above tests, FIG. 7 illustrates the mean (illustrated using a dot) and standard deviation (±σ illustrated using diamonds) of bitterness values produced by in vivo testing (grey dots, diamonds and lines) and by the system according to the presently-preferred embodiment of the invention (black dots, diamonds and lines). It will be seen that, although there is considerable variability in the bitterness values produced by the present system for samples of the same type, there is also noticeable variation in the bitterness values given for such samples by a human panel. Moreover, the good general agreement between in vivo and calculated values is striking.

The drawings and their description hereinbefore illustrate rather than limit the invention. It will be evident that there are numerous alternatives that fall within the scope of the appended claims.

For example, although the presently-preferred embodiment of the present invention makes use of a set of training samples which contains the active principles caffeine, paracetamol, prednisolone and quinine, the invention is not limited to this set of substances. Additional substances can be added to the set, and/or one or more of the named substances can be removed from the above list. When selecting a substance for use in the set of training samples the following considerations should be borne in mind:

the active drug must be bitter;

advantageously, bitterness changes as the concentration of the active drug in the training sample changes;

the substance is soluble in water; and

the overall group of substances covered by the training samples must have perceived bitterness values which span substantially the whole range from unacceptably bitter to non-detectible bitterness.

By extension, the method and apparatus of the present invention can be used in quantifying the bitterness of formulations containing active drugs. Ideally, such formulations would no longer taste bitter (excipients having been added to mask any bitter taste of the active drug present in the formulation). However, it can be useful to check to what extent this masking has been successful. When the present invention is applied for quantifying bitterness of formulations, rather than the active drugs, the preferred training samples are also formulations in which additives have been combined with active drugs.

1. A method of quantifying the bitterness of a sample comprising an active drug, the method comprising the steps of:
providing a calibrated electronic tongue device comprising a plurality of sensors, the electronic tongue device having been calibrated by a process consisting of presenting to the electronic tongue a plurality of training samples having known bitterness values, determining the responses of the electronic tongue sensors to the training samples, and processing the sensor responses whereby to determine a relationship converting between sensor responses and known bitterness values;
presenting the sample to the calibrated electronic tongue device;
determining the responses of the sensors in the electronic tongue to the presented sample; and
processing the determined sensor responses, according to the determined conversion relationship, to produce a bitterness value for the sample.

2. A bitterness-quantification method according to claim 1, and comprising the step of calibrating the electronic tongue device by said process consisting of:
presenting to the electronic tongue a plurality of training samples having known bitterness values,
determining the responses of the electronic tongue sensors to the training samples, and
processing the sensor responses whereby to determine a relationship converting between sensor responses and known bitterness values.

3. A bitterness-quantification method according to claim 2, wherein the calibration step comprises:
determining a relationship converting between sensor responses and known bitterness values by applying a partial least squares (PLS) technique.

4. A bitterness-quantification method according to claim 2, wherein the calibration step further comprises the step of validating the determined conversion relationship by:
presenting to the electronic tongue device a plurality of further samples of known bitterness,
determining the responses of the electronic tongue sensors to the further samples, and
processing the determined sensor responses, according to the determined conversion relationship, to produce bitterness values for the further samples;
comparing the bitterness values produced for the further samples with the known bitterness values thereof whereby to determine a degree of correlation therebetween; and
validating the determined conversion relationship if the degree of correlation is equal to or greater than a threshold value.

5. A bitterness-quantification method according to claim 1, wherein the electronic tongue device comprises ISFET sensors.

6. A bitterness-quantification method according to claim 3, wherein the electronic tongue device comprises ISFET sensors.

7. A method of quantifying the bitterness of an active drug, according to claim 2, wherein the calibration step comprises:
presenting to the electronic tongue a plurality of training samples comprising active drugs, said active drugs can be present at a plurality of different concentrations in a plurality of respective training samples.

8. A method of quantifying the bitterness of an active drug, according to claim 3, wherein the calibration step comprises:
presenting to the electronic tongue a plurality of training samples comprising active drugs, said active drugs can be present at a plurality of different concentrations in a plurality of respective training samples.

9. A method of quantifying the bitterness of an active drug, according to claim 2, wherein the calibration step comprises:
presenting to the electronic tongue a plurality of training samples comprising, respectively, caffeine, famotidine, loperamide, paracetamol, prednisolone, and quinine.

10. A method of quantifying the bitterness of an active drug, according to claim 3, wherein the calibration step comprises:
presenting to the electronic tongue a plurality of training samples comprising, respectively, caffeine, famotidine, loperamide, paracetamol, prednisolone, and quinine.

11. A method of quantifying the bitterness of an active drug, according to claim 7, wherein the calibration step comprises:
presenting to the electronic tongue a plurality of training samples comprising, respectively, caffeine, famotidine, loperamide, paracetamol, prednisolone, and quinine.

12. Apparatus for quantifying the bitterness of an active drug, the apparatus comprising:
a calibrated electronic tongue device comprising a plurality of sensors, the calibrated electronic tongue device having stored therein means for producing a bitterness value by applying a determined conversion relationship to sensor responses generated upon presentation of a sample to the electronic tongue device; and
means for presenting a sample under test to the calibrated electronic tongue device.

13. Bitterness-measurement apparatus according to claim 12, wherein the calibrated electronic tongue device comprises ISFET sensors.

14. A method of quantifying the bitterness of a formulation including an active drug, the method comprising the steps of:
providing a calibrated electronic tongue device comprising a plurality of sensors, the electronic tongue device having been calibrated by a process consisting of presenting to the electronic tongue a plurality of training samples having known bitterness values, determining the responses of the electronic tongue sensors to the training samples, and processing the sensor responses whereby to determine a relationship converting between sensor responses and known bitterness values;
presenting the sample to the calibrated electronic tongue device;
determining the responses of the sensors in the electronic tongue to the presented sample; and
processing the determined sensor responses, according to the determined conversion relationship, to produce a bitterness value for the sample.

15. Apparatus for quantifying the bitterness of a formulation including an active drug, the apparatus comprising:
a calibrated electronic tongue device comprising a plurality of sensors, the calibrated electronic tongue device having stored therein means for producing a bitterness value by applying a determined conversion relationship to sensor responses generated upon presentation of a sample to the electronic tongue device; and
means for presenting a sample under test to the calibrated electronic tongue device.
